(19) United States
(12) Patent Application Publication
(10) Pub. No.: US 2021/0279977 A1
(43) Pub. Date: Sep. 9, 2021

(54) A TELEMATICS SYSTEM FOR A VEHICLE

(71) Applicant: PFK ELECTRONICS (PTY) LTD, Durban (ZA)

(72) Inventors: Alan John SULLIVAN, Durban (ZA); Daniel SANDERSON, Durban (ZA)

(21) Appl. No.: 17/256,512

(22) PCT Filed: Jun. 28, 2019
(86) PCT No.: PCT/IB2019/055496

§ 371 Date: Dec. 28, 2020

(30) Foreign Application Priority Data
Jun. 29, 2018 (ZA) 2018/04370

(51) Int. Cl. G07C 5/00; H04L 12/40; H04L 29/08

(52) U.S. Cl. CPC G07C 5/008; H04L 2012/40215; H04L 67/12; H04L 12/40

(57) ABSTRACT

A telematics system 34 for a vehicle 10 is provided. The vehicle 10 comprises a controller area network bus (CAN-bus) 30, an on-board diagnostics (OBD) system comprising a data port at a first OBD connector part 32 provided on the CAN-bus. The telematics system 34 comprises a basic security system 12 providing a first and limited set of functionalities and a telematics device 36 which is connected to a second OBD connector part 38 which in turn is connectable to the first OBD connector part 32. The telematics device 36 comprises a controller 41, a second wireless transceiver 40 which is connected to controller 41 and which, in use, is in data communication with the first wireless transceiver 24 of the security system 12. A means in the form of a GPS receiver 42 is connected to the controller for providing a second set of functionalities not included in the first limited set of functionalities. A third wireless transceiver 44 is connected to the controller 41 for enabling wireless communications with a remote backend 46.

### INTRODUCTION AND BACKGROUND

This invention relates to a vehicle telemetry system and a method of upgrading a basic vehicle security system to a telemetry system.

At least some models of vehicles are not factory fitted with a vehicle security system. It is known to retrofit to such vehicles a basic and inexpensive security system for use, for example, when the vehicle is exhibited in a large open and publicly accessible display area of a dealer. The basic system, which is deeply concealed in the vehicle and connected to the vehicle battery, typically comprises a controller to which is connected an accelerometer, a clock, an alarm, an immobilizing device and a wireless transceiver. The controller has a “dealership” mode, wherein when movement of the vehicle is sensed by the accelerometer, the controller causes the alarm to be activated and the immobilizer to immobilize the vehicle. The movement may for example be as a result of a prospective thief tampering with the vehicle in the display area. The controller is in data communication with a dealer base station via the transceiver. These known systems are also configured automatically to unlock the doors of the vehicle when a signal transmitted by a universal remote control device carried by a salesperson is received via the transceiver, followed by detection of some other triggering action, such as a light rocking or engagement with or tapping of the vehicle. When so deployed in a dealer display area, the system does not require a GPS or similar receiver and therefore the system is typically not provided with a GPS receiver. When the vehicle is sold and leaves the display area, the controller is switched to an “away” mode wherein the controller is not sensitive or responsive to inputs from the accelerometer or transceiver and the system then goes to sleep and does not perform any further function.

Hence, the device has a limited useful life, that is while the vehicle is in the display area before sale only, and that is a waste of resources and of cost.

### OBJECT OF THE INVENTION

Accordingly, it is an object of the present invention to provide a vehicle telemetry system and a method of upgrading a basic vehicle security system to a vehicle telemetry system with which the applicant believes the aforementioned disadvantages may at least be alleviated or which may provide a useful alternative for the known systems and methods.

### SUMMARY OF THE INVENTION

According to the invention there is provided a telematics system for a vehicle comprising a controller area network bus (CAN-bus), an on-board diagnostics (OBD) system comprising a data port at a first OBD connector part provided on the CAN-bus and a vehicle security system comprising a first wireless transceiver and which vehicle security system provides a first and limited set of functionalities, the telematics system comprising:
a telematics device connected to a second OBD connector part which is connectable to the first OBD connector part;
the telematics device comprising
   a controller;
   second wireless transceiver connected to the controller and which, in use, is in data communication with the first wireless transceiver;
   means connected to the controller for providing a second set of functionalities not included in the first limited set of functionalities provided by the vehicle security system; and
   third wireless transceiver connected to the controller for enabling wireless communications with a remote backend.

The third wireless transceiver may comprise any suitable transceiver such as, but not limited to a Sigfox, LTE, GSM, 4G and 5G transceiver.

The third wireless transceiver may be configured to communicate with the remote backend via the internet of things (IoT).

The telematics device preferably derives power for operation from a vehicle battery via the OBD connector parts, but may also comprise a local battery to enable it to operate in the event that the second OBD connector part is separated from the first OBD connector part.

The first and second wireless transceivers may in use be paired with one another and a secure data link may be established between the first and second wireless transceivers.

One of the functionalities that may be included in the second set of functionalities, is a position or location determining functionality and hence the means connected to the controller may comprise a receiver of a satellite-based radio navigation system, such as global positioning system (GPS).

In some embodiments the vehicle security system may be pre-fitted on the vehicle comprising the CAN-bus and the OBD system comprising the first OBD connector part provided on the CAN-bus. The telematics device may be connected to the first OBD connector part via the second OBD connector part mating with the first OBD connector part.

The invention also extends to a vehicle comprising: a controller area network bus (CAN-bus); an on-board diagnostics (OBD) system comprising a data port at a first OBD connector part provided on the CAN-bus; a vehicle security system providing a first and limited set of functionalities and which vehicle security system comprises a first wireless transceiver; and a telematics device connected to a second OBD connector part which is connectable to the first OBD connector part, the telematics device comprising: a controller; a second transceiver connected to the controller and which, in use, is in data communication with the first wireless transceiver; means connected to the controller for providing a second set of functionalities not included in the first limited set of functionalities; and a third transceiver connected to the controller for enabling wireless communications with a remote backend.

According to another aspect of the invention there is provided a method of upgrading a vehicle security system comprising a first wireless transceiver and which system is deeply concealed in the vehicle, to a vehicle telematics system providing more functionalities than the vehicle security system, the method comprising:
connecting to an on-board diagnostics OBD port on the vehicle a telematics device; the telematics device comprising a second wireless transceiver and a third wireless transceiver;
pairing the first and second wireless transceivers to enable data transfer between the vehicle security system and the telematics device; and
configuring the third transceiver to enable data communications between the telematics device and a remote backend.

### BRIEF DESCRIPTION OF THE ACCOMPANYING DIAGRAMS

The invention will now further be described, by way of example only, with reference to the accompanying diagrams wherein:

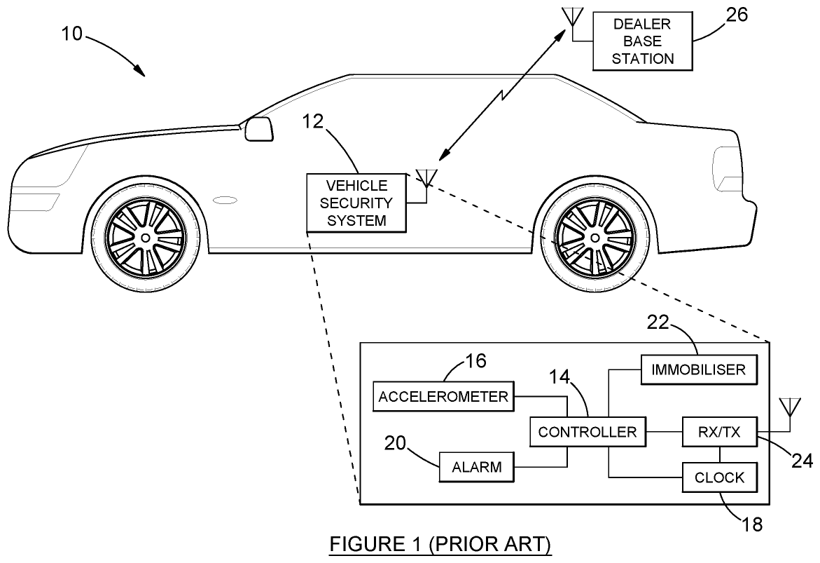

FIG. 1 is a schematic representation of a known host vehicle comprising a known basic vehicle security system;

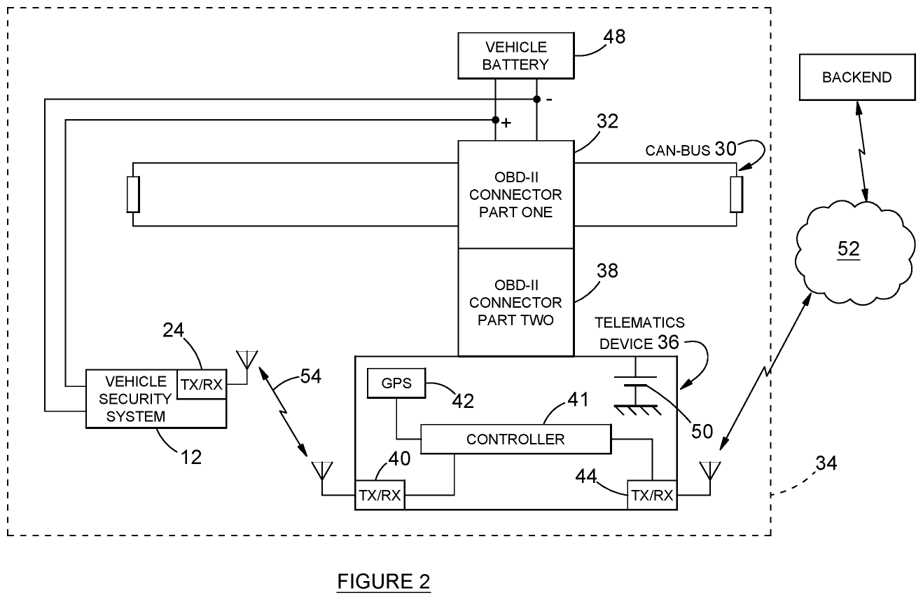

FIG. 2 is a block diagram of a telematics system on the vehicle, the telematics system comprising the known basic vehicle security system and a telematics device connectable to an on-board diagnostics (OBD) port on the vehicle; and

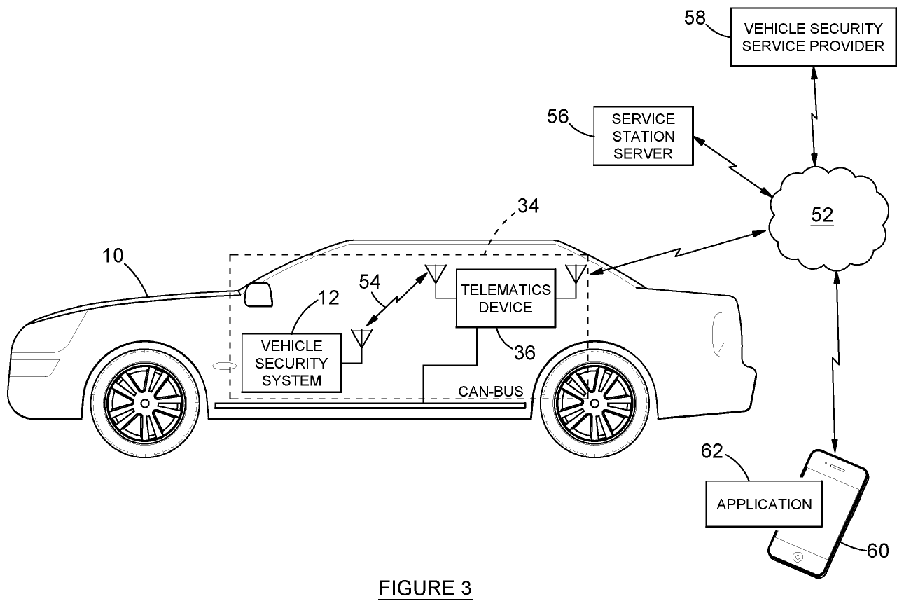

FIG. 3 is a block diagram illustrating wireless communications between the basic vehicle security system and the telematics device and between the telematics system and a server at a service station, a backend of a security service provider and a mobile phone of an owner of the vehicle.

### DESCRIPTION OF A PREFERRED EMBODIMENT OF THE INVENTION

In FIG. 1, there is shown a prior art and known configuration of a host vehicle 10 and a known basic vehicle security system 12 of the kind referred to in the introduction of this specification.

As stated in the introduction, it is known to retrofit to vehicles not comprising a security system, a basic and inexpensive security system for use, for example, when the vehicle is exhibited in a large open and publicly accessible display area of a dealer. The basic system, which is deeply concealed in the vehicle and connected to the vehicle battery, typically comprises a controller 14 to which is connected an accelerometer 16, a clock 18, an alarm 20, an immobilizing device 22 and a first wireless transceiver 24.

The controller 24 has a “dealership” mode, wherein when movement of the vehicle is sensed by the accelerometer 16, the controller causes the alarm 20 to be activated and the immobilizer 22 to immobilize the vehicle. The movement may for example be as a result of a prospective thief tampering with the vehicle in the display area. The controller 14 is in wireless data communication with a dealer base station 26 via the first transceiver 24.

These known systems are also configured automatically to unlock the doors of the vehicle when a signal transmitted by a universal remote control device (not shown) carried by a salesperson is received via the transceiver, followed by detection of some other triggering action, such as a light rocking or engagement with or tapping of the vehicle, as more fully described in the applicant's U.S. Pat. No. 7,327,224B2.

When so deployed in a dealer display area, the security system does not require a GPS or similar receiver, for example, and therefore the system provides a first and limited set of functionalities only. Hence, the system is typically not provided with a GPS receiver. When the vehicle is sold and leaves the display area, the controller is switched to an “away” mode wherein the controller 14 is not sensitive or responsive to inputs from the accelerometer 16 or transceiver 24 and the device then goes to sleep and does not perform any further function.

The basic security system 12 may be upgraded to a vehicle telematics system 34 which provides a second set of functionalities which is not limited to the first set of functionalities.

As shown in FIG. 2, the vehicle 10 comprises a controller area network bus (CAN-bus) 30, an on-board diagnostics (OBD) system (not shown) comprising a data port at a first OBD connector part 32 provided on the CAN-bus.

A telematics system 34 comprises the basic security system 12 and a telematics device 36 which is connected to a second OBD connector part 38 which in turn is connectable to the first OBD connector part 32.

The telematics device 36 comprises a controller 41, a second wireless transceiver 40 which is connected to controller 41 and which, in use, is in data communication with the first wireless transceiver 24 of the basic security system 12. A means 42 is connected to the controller for providing a second set of functionalities not included in the first limited set of functionalities which is provided by the basic vehicle security system 12. In the example embodiment shown, the means comprises a GPS receiver 42. A third wireless transceiver 44 is connected to the controller 41 for enabling wireless communications with a remote backend 46.

The telematics device derives its power from the vehicle battery 48 via the OBD connector parts 32, 38. The telematics device may comprise a small local battery 50 for providing power to the components of the telematics device 36, in the event that the first and second OBD connector parts are separated, for example by a prospective thief, as will be described below.

The third transceiver 44 may comprise any suitable transceiver such as, but not limited to, a Sigfox, LTE, GSM, 4G and 5G transceiver. The third transceiver 44 may be configured to communicate with the remote backend 46 via the internet of things (IoT) 52.

The first and second transceivers 24, 40 may, in use, be paired with one another and a secure data link 54 is established between the first and second transceivers 24, 40.

Hence, the telematics system 34 not only generates security data utilizing the security system 12, but also other data such as position data utilizing the GPS 42 and OBD data via the OBD port of the vehicle. Telematics data comprising at least one of security data and the other data may be transmitted in real time by the third transceiver 44 for reception by the remote backend 46.

The telematics device 36 may be configured repeatedly to poll the OBD system. In the event that there is no response, which may be indicative that the first and second OBD connector parts 32, 38 may have been separated, the telematics device 34, which would then be powered by the local battery 50, would still be able to transmit the telematics data to the backend 46. The telematics device may also be configured, in such an event, to activate the immobilizer of the security system via the data link 54.

In FIG. 3, the backend 46 is shown in some more detail. The backend may comprise a server 56 of a vehicle service station and a vehicle security service provider 58, such as a vehicle tracking and recovery entity.

The telematics system 34 may transmit the above telematics data to any one of these two entities 56, 58, to be processed and acted upon in known manner.

The owner of the vehicle may have access to an application program 62 which is downloadable on a mobile phone 60 from where the owner can selectively access any of the above data as well as messages that may be sent to the owner by the above entities.

The telematics system 34 facilitates the offerings described below.

The first is a so-called “Ride Share” offering. A prospective user of a vehicle uses his mobile device 60 to scan a code, such as a QR code, which is displayed on a windscreen of the vehicle, for example. If the prospective user is registered on the application 62, this QR code will contain encrypted information of the telematics device 36 and the security system 12. The QR code is sent to the backend 46. A first cryptogram is created based on this information and sent from the backend to the telematics device 36. The device 36 decrypts the information and transmits to the security system 12 the information and a message that the prospective user intends to use the vehicle. Based on a unique code and random security data, a second cryptogram is generated by the security system 12 which comprises a sequence required to start the vehicle. Data relating to this sequence is encrypted, stored and sent via the backend to the application 62 on the mobile device 60. The security system 12 causes the immobilizer to be deactivated and the vehicle doors to be unlocked. The prospective user enters the sequence into the telematics system, for example by using buttons on the steering wheel, to start the vehicle, even without an ignition key.

The second is a so-called “Dealership Unlock” offering. A salesperson scans the QR code on the windscreen with his mobile device 60 indicating that he intends opening the vehicle to show it to a customer. The application 62 on the mobile device sends this request, which is encrypted, to the backend 46. A cryptogram is sent to the telematics device 36 in the vehicle where it is decrypted and forwarded to the security system 12. The security system 12 generates an unlock sequence required to start the vehicle, encrypts data relating to same and sends same to the telematics device 36. The security system 12 also causes the vehicle doors to be unlocked and the immobilizer to be deactivated. The telematics device sends the data relating to the sequence via the backend 46 to the mobile device 60 of the salesperson. The application 62 decrypts the data relating to the sequence and provides same in plaintext on the device to the salesperson, to enable the salesperson to start the vehicle as described above.

1. A telematics system for a vehicle comprising a controller area network bus (CAN-bus), an on-board diagnostics (OBD) system comprising a data port at a first OBD connector part provided on the CAN-bus and a vehicle security system comprising a first wireless transceiver and which vehicle security system provides a first and limited set of functionalities, the telematics system comprising:
a telematics device connected to a second OBD connector part which is connectable to the first OBD connector part;
the telematics device comprising
a controller;
second transceiver connected to the controller and which, in use, is in data communication with the first wireless transceiver;
means connected to the controller for providing a second set of functionalities not included in the first limited set of functionalities provided by the vehicle security system; and
a third transceiver connected to the controller for enabling wireless communications with a remote backend.

2. The telematics system of claim 1 wherein the third transceiver comprises at least one of a Sigfox, LTE, GSM, 4G and 5G transceiver.

3. The telematics system of claim 2 wherein the third transceiver is configured to communicate with the remote backend via the internet of things (IoT).

4. The telematics system of claim 1 wherein the telematics device derives power for operation from a battery of the vehicle via the first and second OBD connector parts.

5. The telematics system of claim 4 wherein the telematics device comprises a local battery to power the telematics device in the event that the second OBD connector part is separated from the first OBD connector part.

6. The telematics system of claim 1 wherein the first and second transceivers are paired with one another and a secure data link is established between the first and second transceivers.

7. The telematics system of claim 1 wherein the means connected to the controller for providing a second set of functionalities comprises a receiver of a satellite-based radio navigation system and wherein the second set of functionalities comprises a position determining functionality.

8. A vehicle comprising: a controller area network bus (CAN-bus); an on-board diagnostics (OBD) system comprising a data port at a first OBD connector part provided on the CAN-bus; a vehicle security system providing a first and limited set of functionalities and which vehicle security system comprises a first wireless transceiver; and a telematics device connected to a second OBD connector part which is connectable to the first OBD connector part, the telematics device comprising: a controller; a second transceiver connected to the controller and which, in use, is in data communication with the first wireless transceiver; means connected to the controller for providing a second set of functionalities not included in the first limited set of functionalities; and a third transceiver connected to the controller for enabling wireless communications with a remote backend.

9. A method of upgrading a vehicle security system comprising a first wireless transceiver and which system is deeply concealed in the vehicle to a vehicle telematics system providing more functionalities than the vehicle security system, the method comprising:
connecting to an on-board diagnostics OBD port on the vehicle a telematics device; the telematics device comprising a second wireless transceiver and a third wireless transceiver;
pairing the first and second wireless transceivers to enable data transfer between the vehicle security system and the telematics device; and
configuring the third transceiver to enable data communications between the telematics device and a remote backend.
